(19) United States
(12) Patent Application Publication
(10) Pub. No.: US 2012/0288736 A1
(43) Pub. Date: Nov. 15, 2012

(54) ENERGY STORAGE APPARATUS AND METHOD FOR MANUFACTURING THE SAME

(75) Inventors: Yong Suk KIM, Gyeonggi-do (KR); Young Seuck Yoo, Seoul (KR); Kang Heon Hur, Gyeonggi-do (KR)

(73) Assignee: Samsung Electro-Mechanics Co., Ltd., Suwon (KR)

(21) Appl. No.: 13/455,898

(22) Filed: Apr. 25, 2012

(30) Foreign Application Priority Data
May 12, 2011 (KR) 10-2011-0044585

(51) Int. Cl. H01M 2/16; B05D 5/12; H01M 4/66

(52) U.S. Cl. 429/10; 427/77; 427/78

(57) ABSTRACT

Disclosed herein are an energy storage apparatus including a magnetic layer formed on any one of a positive electrode, a negative electrode, and a separator, or an exterior frame, and a method for manufacturing the same. With the energy storage apparatus, the magnetic layer is provided in a vicinity of the separator in order to increase ion conductivity or a magnetic material is contained on surfaces of positive electrode and negative electrode current collectors or in positive electrode and negative electrode active materials, such that conductivity and mobility of lithium ions between the positive electrode and the negative electrode are increased, thereby making it possible to improve a charging and discharging speed. In addition, a shortage due to an ion trap and a defect according to shrinkage ratio may be improved.

### CROSS REFERENCE(S) TO RELATED APPLICATIONS

This application claims the benefit under 35 U.S.C. Section 119 of Korean Patent Application Serial No. 10-2011-0044585, entitled “Energy Storage Apparatus And Method For Manufacturing The Same” filed on May 12, 2011, which is hereby incorporated by reference in its entirety into this application.

### BACKGROUND OF THE INVENTION

1. Technical Field

The present invention relates to an energy storage apparatus and a method for manufacturing the same, and more particularly, to an energy storage apparatus having improved charging and discharging characteristics by increasing ion conductivity, and a method for manufacturing the same.

2. Description of the Related Art

Problems such as global warming and energy depletion are caused due to a rapid increase in use of fossil energy. A battery, which is an energy storage apparatus, also causes the above-mentioned problems.

According to the related art, hydrogen and lithium primary batteries were used, such that a problem such as a short lifespan and a problem associated with an environment and a cost such as an increase in a cost due to treatment of a waste material and a manufacturing cost, and the like, have been generated. In order to solve these problems and preserve the earth environment through reuse of resources and low carbon green growth, which have been globally spotlighted, a market using a secondary battery as an energy source has been actively created for automobiles, heavy equipment, an information technology (IT) devices, and the like, which are the main culprits of environmental pollution due to the use of a fossil fuel. It is expected that the secondary battery will have a large ripple effect on the future market. It is expected that the demand of the battery in accordance with various performances will explosively increase, particularly in a portable IT device field such as a cellular phone, a notebook computer, an information element, and the like, and an automobile field.

A secondary battery, which is one of the energy storage devices, may be manufactured by separating a positive electrode 10 including a positive electrode current collector 11 and a positive electrode active material layer 12 applied to the positive electrode current collector 11 and a negative electrode 22 including a negative electrode current collector 21 and a negative electrode active material layer 22 applied to the negative electrode current collector 21 from each other by a separator 30 and impregnating the positive electrode 10 and the negative electrode 20 in an electrolyte solution 40, as shown in FIG. 1. In addition, the electrode current collector manufactured as described above is packed using an exterior frame such as a pouch, thereby making it possible to manufacture a final secondary battery.

In order to form the respective layers, the respective layers are individually manufactured and then are subject to additional processes such as a stacking or laminating process, a packing process, thereby causing a reduction in process efficiency and a deterioration of charging and discharging characteristics due to mismanagement of humidity and impurities, simultaneously with causing defects due to the respective process faults.

The existing secondary battery was manufactured by forming an aluminum current collector including a lithium metal complex oxide containing at least one of cobalt, nickel, manganese, and the like, to thereby form a positive electrode agent; forming a copper current collector including at least one of a carbon material such as an activated carbon, a graphite, a Sn-based composite oxide containing a metal such as P, Al, SI, Ge, and the like, and a lithium titanium oxide to thereby form a negative electrode agent; preparing an electrolyte solution including at least one of ethylenecarbonate, dimethylenecarbonate, polycarbonate, ethylmethylcarbonate; forming a separator formed of a microporous membrane made of polyolefins such as polyethylene, polypropylene, and the like, impregnating the separator in the electrolyte solution, bonding the positive electrode agent and the negative electrode agent to each other, and packing an external terminal using a pouch simultaneously with forming the external terminal.

In the case of using the above-mentioned process, a current density of a positive electrode is reduced and a bonding defect is generated between the respective layers, due to an ion trap caused by unstable movement of lithium ions at an interface between the respective layers. In addition, charging and discharging characteristics, rate characteristics, and a lifespan of the secondary battery are deteriorated due to non-uniform impregnation of the separator in the electrolyte solution and instability of conduction of the lithium ions.

Further, when the secondary battery is used for a long time, the lithium ions are trapped due to deterioration caused by instability of separation from and insertion thereof into a positive electrode layer and a negative electrode layer to form a lithium dendrite, thereby causing deterioration of mechanical strength of the separator, simultaneously with causing deterioration in the capacitance of the secondary battery.

### SUMMARY OF THE INVENTION

An object of the present invention is to provide an energy storage device having improved charging and discharging characteristics by increasing ion conductivity of lithium ions and securing overtemperature, shutdown, and heat resistance.

Another object of the present invention is to provide a method for manufacturing an energy storage apparatus.

According to an exemplary embodiment of the present invention, there is provided an energy storage apparatus including: a positive electrode; a negative electrode; and a separator, wherein the separator includes magnetic layers formed thereon.

The separator may be made of at least one selected from a group consisting of polyvinylidenefluoride (PVDF), polyvinylidenefluoride-hexafluoropropylene (PVDF-HFP), nylon, polyurethane, polymethylmethacrylate (PMMA), polyacrylonitrile (PAN), polyvinylalcohol (PVA), Teflon resin (PTFE), polyimide, and ethylmethylcellulose.

The magnetic layer may be made of at least one selected from a group consisting of Ni—Fe, Fe—SI, a Tb-based alloy, an Nd-based alloy, and an Sm-based alloy.

A material of the magnetic layer may be contained in a material of the separator or the magnetic layer may be formed on one surface or both surfaces of the separator.

When the material of the magnetic layer is contained in the material of the separator, the material of the magnetic layers may be contained in 10 to 30 wt % based on the material of the separator.

According to another exemplary embodiment of the present invention, there is provided an energy storage apparatus including: a positive electrode; a negative electrode; and a separator, wherein any one of positive electrode and negative electrode current collectors includes a magnetic layer formed thereon.

Any one of the positive electrode and negative electrode current collectors may include an insulation layer formed thereon.

The magnetic layer may be made of at least one selected from a group consisting of Ni—Fe, Fe—SI, a Tb-based alloy, an Nd-based alloy, and an Sm-based alloy.

According to another exemplary embodiment of the present invention, there is provided an energy storage apparatus including: a positive electrode; a negative electrode; and a separator, wherein any one of positive electrode and negative electrode active material layers includes a magnetic layer formed thereon.

A material of the magnetic layer may be contained in a material of any one of positive electrode and negative electrode active material layers and the magnetic layer may be formed on any one of the positive electrode and negative electrode active material layers.

When the material of the magnetic layer is contained in the material of any one of the positive electrode and negative electrode active material layers, the material of the magnetic layer may be contained in 10 to 30 wt % based on the material of any one of the positive electrode and negative electrode active material layers.

According to another exemplary embodiment of the present invention, there is provided an energy storage apparatus including: an electrode assembly including a positive electrode, a negative electrode, and a separator; and a case receiving the electrode assembly therein, wherein the case includes a magnetic layer formed on a portion or the entirety thereof.

The case may be a pouch typed case.

According to another exemplary embodiment of the present invention, there is provided a method for manufacturing an energy storage apparatus, the method including: manufacturing a positive electrode, a negative electrode, and a separator; forming a magnetic layer on any one of the positive electrode, the negative electrode, and the separator; impregnating the positive electrode, the negative electrode, and the separator of which any one includes the magnetic layer formed thereon in an electrolyte solution; and receiving the positive electrode, the negative electrode, and the separator of which any one includes the magnetic layer formed thereon in a case.

The magnetic layer may be formed by at least one selected among an electrospinning method, a spray coating method, a casting method, and a dip coating method.

The magnetic layer may be formed on positive electrode and negative electrode current collectors.

The method may further include forming an insulation layer on the positive electrode and negative electrode current collectors before forming of the magnetic layer.

A material of the magnetic layer may be contained in a material of positive electrode and negative electrode active material layers or the magnetic layer may be formed on the positive electrode and negative electrode active material layers.

A material of the magnetic layer may be contained in a material of the separator or the magnetic layer may be formed on one surface or both surfaces of the separator.

According to another exemplary embodiment of the present invention, there is provided a method for manufacturing an energy storage apparatus, the method including: manufacturing a positive electrode, a negative electrode, and a separator; impregnating the positive electrode, the negative electrode, and the separator in an electrolyte solution; receiving the positive electrode, the negative electrode, and the separator in a case; and forming a magnetic layer on a portion or the entirety of the case.

### BRIEF DESCRIPTION OF THE DRAWINGS

FIG. 1 is a view showing a structure of a secondary battery, which is the energy storage apparatus according to the related art; and

FIGS. 2 to 5 are views showing a structure of a secondary battery according to an exemplary embodiment of the present invention.

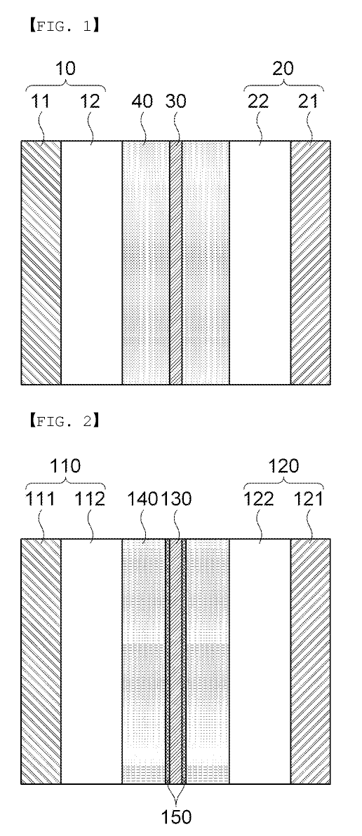

### DESCRIPTION OF THE PREFERRED EMBODIMENTS

Hereinafter, an energy storage apparatus according to an exemplary embodiment of the present invention will be described in more detail with reference to the accompanying drawings. However, the present invention is not limited thereto.

An energy storage apparatus according to an exemplary embodiment of the present invention has a structure in which it includes at least one magnetic layer formed on a positive electrode, a negative electrode, a separator, an exterior frame, and the like, which configures the energy storage apparatus.

Generally, in the case of an energy storage apparatus capable of being charged and discharged, when a positive electrode including a positive electrode agent and a negative electrode including a negative electrode agent are impregnated in an electrolyte solution, an discharging operation is performed at the time of movement of lithium ions dissolved in the electrolyte solution from the negative electrode agent to the positive electrode agent and a charging operation is performed at the time of movement of the lithium ions from the positive electrode agent to the negative electrode agent. As a result, the charging and discharging operations are continuously performed.

Lithium ions needs to rapidly move and to uniformly move over the entire area of the positive and negative electrode agents in order that the charging and discharging operations are chemically performed stably and transfer of the lithium ions is not prevented even at a high temperature. In this case, an efficiency and a lifespan of the battery may be increased.

In order to implement this, the magnetic layer is formed on any one of each component configuring the energy storage apparatus, in the present invention.

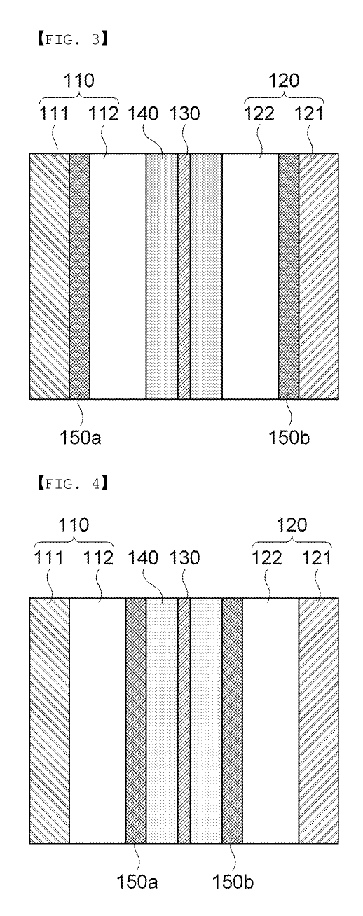

FIG. 2 shows a structure of an energy storage apparatus according to an exemplary embodiment of the present invention. Referring to FIG. 2, a positive electrode 110 including a positive electrode current collector 111 and a positive electrode active material layer 112 applied to the positive electrode current collector 111 and a negative electrode 120 including a negative electrode current collector 121 and a negative electrode active material layer 122 applied to the negative electrode current collector 121 are separated from each other by a separator 130, and a magnetic layer 150 is formed on one surface or both surfaces of the separator. The positive and negative electrodes 110 and 120 and the separator 130 are impregnated in an electrolyte solution 140 and are received in an exterior frame (not shown), thereby making it possible to manufacture a final energy storage apparatus.

The magnetic layer 150 is coated on one surface or both surfaces of the separator 130 in order to improve an ion conductivity effect by forming an electric field between N and S poles simultaneously with separating the positive electrode 110 and the negative electrode 120 from each other.

In addition, the magnetic layer 150 may be formed on one surface of the separator 130 or be formed as separate layers on both surfaces thereof. Alternately, materials for forming the magnetic layer are mixed with materials for forming the separator, such that magnetic materials may be contained in the separator at the time of formation of the separator.

Here, the magnetic layer may be made of at least one selected from a group consisting of Ni—Fe, Fe—SI, a Tb-based alloy, an Nd-based alloy, and an Sm-based alloy.

The magnetic layer may be formed by appropriately performing coating on one surface or both surfaces of the separator by a method selected among a spray coating method, an inkjet method, an electrospinning method, and a dip coating method. However, a method for forming the magnetic layer is not limited thereto.

The separator according to an exemplary embodiment of the present invention is made of at least one selected from a group consisting of polyvinylidenefluoride (PVDF), polyvinylidenefluoride-hexafluoropropylene (PVDF-HFP), nylon, polyurethane, polymethylmethacrylate (PMMA), polyacrylonitrile (PAN), polyvinylalcohol (PVA), Teflon resin (PTFE), polyimide, and ethylmethylcellulose, without being limited thereto.

When a porous separator having excellent permeability is manufactured by mixing the magnetic material and the material of the separator with each other, 10 to 30 wt % of magnetic material may be added to the material of the separator in order to maximize an ion transfer effect.

FIG. 3 shows a structure of an energy storage apparatus according to an exemplary embodiment of the present invention. Referring to FIG. 3, a positive electrode 110 including a positive electrode current collector 111 and a positive electrode active material layer 112 and a negative electrode 120 including a negative electrode current collector 121 and a negative electrode active material layer 122 are separated from each other by an separator 130, a magnetic layer 150a is formed between the positive electrode current collector 111 and the positive electrode active material layer 112, and a magnetic layer 150b is formed between the negative electrode current collector 121 and the negative active material layer 122. The positive and negative electrodes 110 and 120 and the separator 130 are impregnated in an electrolyte solution 140 and are received in an exterior frame (not shown), thereby making it possible to manufacture a final energy storage apparatus.

The magnetic layer formed on the electrode current collector is made of the material as described above.

The positive electrode current collector 111 according to an exemplary embodiment of the present invention may be made of at least one selected from a group consisting of aluminum, stainless steel, copper, nickel, titanium, tantalum and niobium, without being limited thereto. The positive electrode current collector may be made of a material used in the electric double layer capacitor or the lithium ion battery according to the related art and may have a thickness of about 10 to 300 μm. In addition, as the positive electrode current collector, a member having a hole penetrated from a front surface to a rear surface, such as an etched metal foil, a punched metal, a mesh, a foam, and the like, as well as a metal foil made of the above-mentioned metal, may be used.

The negative electrode current collector according to an exemplary embodiment of the present invention may be made of at least one metal selected from a group consisting of copper, nickel, stainless steel, and an alloy thereof without being limited thereto. The negative electrode current collector may be made of a material used in the electric double layer capacitor or the lithium ion battery according to the related art and may have a thickness of about 10 to 300 μm. In addition, as the negative electrode current collector, a member having a hole penetrated from a front surface to a rear surface, such as an etched metal foil, a punched metal, a mesh, a foam, and the like, as well as a metal foil made of the above-mentioned metal, may be used.

When the magnetic layers are formed on the positive electrode and negative electrode current collectors, there may be a risk of generation of a short-circuit between the positive electrode and negative electrode current collectors and the magnetic layers. Therefore, insulation layers may be first applied to the positive electrode and negative electrode current collectors and the magnetic layers may be formed on the insulation layers, as needed.

A material of the insulation layer is not specifically limited as long as it may separate the positive electrode and negative electrode current collectors from the magnetic layers.

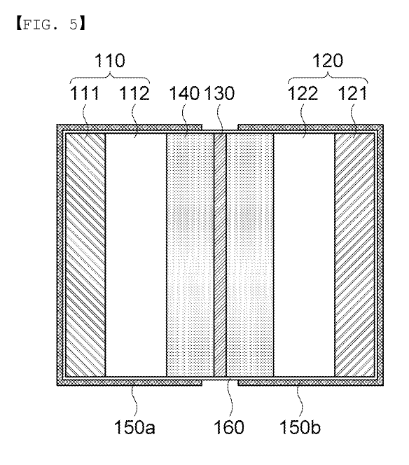

FIG. 4 shows a structure of an energy storage apparatus according to an exemplary embodiment of the present invention. Referring to FIG. 4, a positive electrode 110 including a positive electrode current collector 111 and a positive electrode active material layer 112 applied to the positive electrode current collector 111 and a negative electrode 120 including a negative electrode current collector 121 and a negative electrode active material layer 122 applied to the negative electrode current collector 121 are separated from each other by a separator 130, a magnetic layer 150a is formed on the positive electrode active material layer 112, and a magnetic layer 150b is formed on the negative active material layer 122. The positive and negative electrodes 110 and 120 and the separator 130 are impregnated in an electrolyte solution 140 and are received in an exterior frame (not shown), thereby making it possible to manufacture a final energy storage apparatus.

The positive electrode and negative electrode current collectors according to an exemplary embodiment of the present invention has been described above in detail.

The magnetic layers formed on the positive electrode and negative electrode active material layers are made of the material as described above.

In addition, the positive electrode active material layer may be made of at least one lithium-containing composite oxide selected from a group consisting of LiMnPO₄, (Li₃V₂(PO₄)₃), Li₄Ti₅O₁₂, and LiMSiP₄ without being limited thereto.

The negative electrode active material layer may be made of a carbon-based material such as a graphite, a carbon nano tube (CNT) without being limited thereto.

In addition, the positive electrode and negative electrode active material layers may contain the known binder, conductive material, and solvent in addition to each of the above-mentioned active materials.

In the present invention, when the magnetic layers are formed on the active material layer, they may be formed as separate layers on the positive electrode active material layer 112 and the negative electrode active material layer 122. Alternatively, the magnetic layer may be formed as a single layer by mixing the magnetic material with the positive electrode active material and the negative electrode active material.

When the magnetic material is mixed with the active material, it may be added to the positive electrode and negative electrode active materials in 10 to 30 wt % in order to increase ion mobility.

As described above, the magnetic layers are formed on the positive electrode and negative electrode current collectors or the positive electrode and negative electrode active material layers to increase an electric field, such that the negative electrode material and the positive electrode material are uniformly and entirely ionized in atom and electron states due to acceleration of the electrons, thereby making it possible to increase a current amount. In addition, the magnetic material is mixed with and coated on the positive electrode and negative electrode active materials, thereby making it possible to increase ion mobility due to the Lorentz effect.

FIG. 5 shows a structure of an energy storage apparatus according to an exemplary embodiment of the present invention. Referring to FIG. 5, an electrode assembly in which a positive electrode 110 including a positive electrode current collector 111 and a positive electrode active material layer 112 applied to the positive electrode current collector 111 and a negative electrode 120 including a negative electrode current collector 121 and a negative electrode active material layer 122 applied to the negative electrode current collector 121 are separated from each other by a separator 130 is impregnated in an electrolyte solution 140 and is received in an exterior frame 160. Then, a magnetic layer 150 is formed on a portion of the exterior frame.

A case for receiving the electrode assembly therein may be a polymer pouch typed case without being limited thereto.

If needed, the magnetic layer may also be formed before the electrode assembly is received in the exterior frame.

In addition, the magnetic layer formed on the exterior frame may be made of the material as described above. In addition, the magnetic layer may be formed on a portion or over the entirety of the exterior frame. When the magnetic layer is formed on a portion of the exterior frame, a position at which the magnetic layer is formed is not specifically limited.

The electrode assembly including the positive electrode, the negative electrode, and the separator is received in the case such as the pouch typed case and the magnetic material is coated on a circumference of an outline of a cell, thereby making it possible to improve charging and discharging characteristics due to an electric field effect.

As described in the present invention, a secondary battery cell including the magnetic material is used to smoothly conduct the lithium ions in the vicinity of the positive electrode active material and the negative electrode active material and uniformly insert and separate the lithium ions over the entire area, such that a movement speed of a current increases, thereby making it possible to improve charging and discharging speeds.

It may be expected that the lithium ions has ferromagnetic properties, such that mobility of the lithium ions may be increased due to the magnetic layer included in various forms.

In addition, the battery cell includes the magnetic layer as described above, such that static electricity, interference due to an electric wave from the outside, and the like, that may occur in the battery cell are prevented, thereby making it possible to smoothly drive the battery cell.

The energy storage apparatus according to the present invention significantly removes a lithium dendrite due to the deterioration of the electrolyte solution simultaneously with securing a secure energy density, thereby making it possible to generate a surface reaction of the lithium ions on surfaces of the positive and negative electrodes. Therefore, a cell having various shapes such as a cylindrical shape, a square shape, a pouch shape, and the like, may be manufactured.

According to the exemplary embodiment of the present invention, the magnetic layer is provided in the vicinity of the separator in order to increase ion conductivity or a magnetic material is contained on surfaces of the positive electrode and negative electrode current collectors or in the positive electrode and negative electrode active materials, such that conductivity and mobility of lithium ions between the positive electrode and the negative electrode are increased, thereby making it possible to improve a charging and discharging speed. In addition, a shortage due to an ion trap and a defect according to shrinkage ratio may be improved.

Further, compositions and structures of various forms of separators may be controlled, thereby making it possible to use the energy storage apparatus for both of a large capacitance application and a small capacitance application. An energy storage apparatus having reduced process time and high reliability such as chemical resistance and durability may be manufactured.

Furthermore, the magnetic material is coated around a cell of the pouch typed case receiving an electrode assembly to prevent interference due to an electric wave from the outside and allow a current to smoothly flow, thereby making it possible to improve ion capacity maintenance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An energy storage apparatus comprising:
a positive electrode;
a negative electrode; and
a separator,
wherein the separator includes magnetic layers formed thereon.

2. The energy storage apparatus according to claim 1, wherein the separator is made of at least one selected from a group consisting of polyvinylidenefluoride (PVDF), polyvinylidenefluoride-hexafluoropropylene (PVDF-HFP), nylon, polyurethane, polymethylmethacrylate (PMMA), polyacrylonitrile (PAN), polyvinylalcohol (PVA), Teflon resin (PTFE), polyimide, and ethylmethylcellulose.

3. The energy storage apparatus according to claim 1, wherein the magnetic layer is made of at least one selected from a group consisting of Ni—Fe, Fe—SI, a Tb-based alloy, an Nd-based alloy, and a Sm-based alloy.

4. The energy storage apparatus according to claim 1, wherein a material of the magnetic layer is contained in a material of the separator or the magnetic layer is formed on one surface or both surfaces of the separator.

5. The energy storage apparatus according to claim 4, wherein when the material of the magnetic layer is contained in the material of the separator, the material of the magnetic layers is contained in 10 to 30 wt % based on the material of the separator.

6. An energy storage apparatus comprising:
a positive electrode;
a negative electrode; and
a separator,
wherein any one of positive electrode and negative electrode current collectors includes a magnetic layer formed thereon.

7. The energy storage apparatus according to claim 6, wherein any one of the positive electrode and negative electrode current collectors includes an insulation layer formed thereon.

8. The energy storage apparatus according to claim 6, wherein the magnetic layer is made of at least one selected from a group consisting of Ni—Fe, Fe—SI, a Tb-based alloy, an Nd-based alloy, and an Sm-based alloy.

9. An energy storage apparatus comprising:
a positive electrode;
a negative electrode; and
a separator,
wherein any one of positive electrode and negative electrode active material layers includes a magnetic layer formed thereon.

10. The energy storage apparatus according to claim 9, wherein a material of the magnetic layer is contained in a material of any one of the positive electrode and negative electrode active material layers and the magnetic layer is formed on any one of the positive electrode and negative electrode active material layers.

11. The energy storage apparatus according to claim 10, wherein when the material of the magnetic layer is contained in the material of any one of the positive electrode and negative electrode active material layers, the material of the magnetic layer is contained in 10 to 30 wt % based on the material of any one of the positive electrode and negative electrode active material layers.

12. An energy storage apparatus comprising:
an electrode assembly including a positive electrode, a negative electrode, and a separator; and
a case receiving the electrode assembly therein,
wherein the case includes a magnetic layer formed on a portion or the entirety thereof.

13. The energy storage apparatus according to claim 12, wherein the case is a pouch typed case.

14. A method for manufacturing an energy storage apparatus, the method comprising:
manufacturing a positive electrode, a negative electrode, and a separator;
forming a magnetic layer on any one of the positive electrode, the negative electrode, and the separator;
impregnating the positive electrode, the negative electrode, and the separator of which any one includes the magnetic layer formed thereon in an electrolyte solution; and
receiving the positive electrode, the negative electrode, and the separator of which any one includes the magnetic layer formed thereon in a case.

15. The method according to claim 14, wherein the magnetic layer is formed by at least one selected among an electrospinning method, a spray coating method, a casting method, and a dip coating method.

16. The method according to claim 14, wherein the magnetic layer is formed on positive electrode and negative electrode current collectors.

17. The method according to claim 16, further comprising forming an insulation layer on the positive electrode and negative electrode current collectors before forming of the magnetic layer.

18. The method according to claim 14, wherein a material of the magnetic layer is contained in a material of positive electrode and negative electrode active material layers or the magnetic layer is formed on the positive electrode and negative electrode active material layers.

19. The method according to claim 14, wherein a material of the magnetic layer is contained in a material of the separator or the magnetic layer is formed on one surface or both surfaces of the separator.

20. A method for manufacturing an energy storage apparatus, the method comprising:
manufacturing a positive electrode, a negative electrode, and a separator;
impregnating the positive electrode, the negative electrode, and the separator in an electrolyte solution;
receiving the positive electrode, the negative electrode, and the separator in a case; and
forming a magnetic layer on a portion or the entirety of the case.

21. The method according to claim 20, wherein the magnetic layer is formed before the receiving of the positive electrode, the negative electrode, and the separator in the case.
